(19) United States
(12) Patent Application Publication
(10) Pub. No.: US 2015/0220430 A1
(43) Pub. Date: Aug. 6, 2015

(54) GRANTED MEMORY PROVIDING SYSTEM AND METHOD OF REGISTERING AND ALLOCATING GRANTED MEMORY

(71) Applicant: Electronics and Telecommunications Research Institute, Daejeon (KR)

(72) Inventor: Young Ho KIM, Daejeon (KR)

(73) Assignee: Electronics and Telecommunications Research Institute, Daejeon (KR)

(21) Appl. No.: 14/310,259

(22) Filed: Jun. 20, 2014

(30) Foreign Application Priority Data
Feb. 4, 2014 (KR) 10-2014-0012561

(51) Int. Cl. G06F 12/02; H04L 29/08; G06F 13/28; H04L 12/24

(52) U.S. Cl. CPC G06F 12/0223; H04L 41/12; H04L 67/1097; G06F 13/28; G06F 2212/154

(57) ABSTRACT

The present invention relates to a system and method of registering and allocating a granted memory based on a topology of a granted node in a distributed integrated memory system. There is provided a granted memory providing system capable of minimizing a memory allocation time, a service access time, and a response time. In the system, when the granted memory of the granted node is registered, a topology map is generated based on a connection structure of a host channel adapter, a processor, and a memory of the granted node. The granted memory is registered and allocated based on the generated topology map so that the granted memory is efficiently configured and a memory area is registered.

### CROSS-REFERENCE TO RELATED APPLICATION

This application claims priority to and the benefit of Korean Patent Application No. 10-2014-0012561, filed on Feb. 4, 2014, the disclosure of which is incorporated herein by reference in its entirety.

### BACKGROUND

1. Field of the Invention

The present invention relates to a distributed integrated memory system in a high-speed and low-latency network environment, and specifically, to technology capable of minimizing a time for memory allocation and a response time of service access by efficiently configuring a high-capacity granted memory of a remote granted node and registering a memory area.

2. Discussion of Related Art

In the field of high performance computing, in order to analyze and process a large amount of data such as a big data application, need for a high-speed storage device and a high-speed mass memory is increasing. In terms of hardware and technology development, compared to a computing capacity development speed and a required data processing capacity, a provided memory capacity and performance is relatively insufficient. An insufficient data processing performance phenomenon is caused by a difference of a storage, a storage capacity of a memory, an access delay time, and the like, and acts as a bottleneck of high-speed and high-capacity data processing.

In order to address a demand for a high-speed and high-capacity memory, research on a memory expanding system and a distributed integrated memory utilizing a part of a remote node memory has been actively performed. According to development of remote direct memory access (RDMA) technology that can directly access a remote memory based on a low-latency and high-speed network and the like, a remote distributed memory service is possible in a large-scale system. The RDMA is technology for transmitting data between memories via a high-speed network.

Specifically, the RDMA provides a function of directly transmitting remote data from a memory to a memory without using a CPU. A memory cloud uses a plurality of remote granted memory nodes to configure a high-capacity distributed integrated memory, and provides a service by allocating a memory to a client node requesting a memory service through a distributed integrated memory server manager.

FIG. 1A is a diagram illustrating a concept of a conventional memory cloud service through a plurality of remote memory granted nodes.

A memory cloud service based on a distributed remote granted memory mainly includes three components. The components include a client node 100 that is a consumer of a memory service, a meta server 120 that configures a memory cloud serving as a distributed integrated memory through a distributed granted memory node, receives a request of a memory service from the client node, allocates a granted node memory area responsible for an actual memory service to the client, and provides a service, and a granted node 130 that provides an actual physical memory area by allocation of the meta server, and registers and controls a granted memory area.

The remote granted node 130 allocates and manages a predetermined part of a local memory in the node as a granted memory. The meta server 120 manages granted memories of the plurality of granted nodes 130 as a single memory cloud 140, and provides the memory to a client node 100 requesting a memory service. The client node 100 requests allocation of a remote memory from the memory cloud on the meta server 120, maps the allocated remote memory area with a restricted local memory area for managing remote memory, and provides the memory service to an application of a user area.

FIG. 1B is a diagram illustrating a concept of memory service mapping in a memory cloud environment.

In order to use a memory of the memory cloud 140, an application process of the client node is allocated with as virtual address 160. When the process accesses a memory area 110 of the allocated virtual address 160, mapping with a physical memory area is performed. As the physical memory area that is actually provided in the memory cloud 140, a physical memory space 150 of the remote granted node 130 provided through the memory cloud 140 is allocated and used. Similar to a memory use of a local node, when the allocated memory is accessed for actual computation, a memory fault is generated when the actual physical memory is not mapped with a corresponding allocated memory area. At this time, mapping with the actual physical memory is performed. In the memory cloud 140, instead of a local physical memory area, the granted memory area of the remote distributed granted memory node provided through the meta server is mapped and used, and tasks related to the memory such as memory read or write are performed.

Meanwhile, due to development of hardware technology, a capacity and complexity of resources used in a high performance computing system is increasing. The processor (CPU) has been developed into a multi-core and a structure having a plurality of sockets. A memory capacity can be expanded to several hundred gigabytes per node. A non-uniform memory access (NUMA) topology has a structure in which a memory module on which a memory can be installed is separately provided for each CPU socket, and a different access cost is incurred between memories of the same node according to a location of attached processor socket.

An interconnection structure of the CPU, the memory, and a host channel adapter (HCA) is connected through each CPU socket and PCI when a plurality of HCAs are connected. In order to provide the granted memory for the remote client node using a high-capacity memory of the granted node, the plurality of HCAs supporting a physical memory service through the RDMA need to be used. In RDMA communication, in order to decrease a CPU overhead of the granted node and minimize an access delay time for physical memory area, an operation support of a memory semantic is necessary. In order for the client node to directly access the physical memory area of the remote granted node, a memory area registration task of mapping and registering the virtual address and the physical address space in the HCA is necessary. The memory area registration task is internally performed in units of physical pages of a system. When a size of a registration memory area increases, a registration cost increases logarithmically rather than linearly.

FIG. 2A illustrates main resources and an interconnection structure currently used in most high performance computing systems.

An interconnection structure of CPUs 210 and 211, memories 220 and 221, and HCAs 240 and 241 is connected to each CPU socket and PCI when a plurality of HCAs are connected. Each socket has a separate memory, and operates in the NUMA topology in which each CPU has a different memory access distance.

In the single HCA₀ 240, there is a difference between an access speed for a memory area of the DRAM₀ 220 connected to the CPU₀ 210 of a directly connected socket and an access speed for a memory area of the DRAM₁ 221 connected to the CPU₁ 211 of another socket. In order to access the DRAM₁ 221 that is a memory area of another socket, an additional cost of passing the CPU₁ 211 is incurred. In order for a process of the remote client node to directly access the granted memory area through the RDMA, a memory registration task is necessary.

FIG. 2B is a diagram illustrating a concept of memory registration of a granted memory node without consideration of a topology.

The memory area registration task is a task of mapping and registering an allocation area 270 of a virtual address space 260 of a granted node 200 with the physical memory 220 such that the remote client node directly accesses and uses the memory through the RDMA. A fixing task of a memory and a task of converting an address and registering a memory are performed such that the HCAs 240 and 241 may directly use the memory. When the memory registration task is completed, registered memory information is stored in a memory translation table (MTT) of the HCAs 240 and 241, and is referred to when the memory area is accessed and is provided through the RDMA.

However, when the granted memory is registered without consideration of the interconnection structure of the HCA and the CPU, the area of the DRAM₁ 221 of the physical memory in a socket that is not directly connected to the HCA₀ 240 may be allocated and registered. When the memory of the socket that is not connected to the HCA is allocated and registered, if the remote client node requests a service after the memory is allocated, access to the allocated memory area is delayed and a response time increases, thereby degrading performance.

In the related art, a granted memory size of the granted node has a size that can tolerate performance degradation without consideration of the plurality of HCAs. However, in consideration of a current developing speed of the system, granted memory registration and allocation using the plurality of HCAs is essential. In addition, when the granted memory is registered and then the memory cloud service is provided through the meta server, granted memory allocation in consideration of the plurality of HCAs is necessary. In allocation for the same granted memory node, when there are the plurality of HCAs, it is necessary to process such that the granted memory areas in the plurality of HCAs are equally allocated. When allocation is not equally performed but only a memory area in a specific HCA is allocated, a total response time of the memory area increases, thereby degrading performance.

Therefore, when the memory service of the granted memory of the remote node that supports memory allocation and registration based on the interconnection structure of the memory and the HCA through topology recognition is not provided, an accessing latency of the granted memory area increases and memory allocation is concentrated on the memory connected to a specific HCA. Therefore, a response time increase is inevitable and thus performance of the memory cloud service decreases.

### SUMMARY OF THE INVENTION

In view of the above-described problems, the present invention provides a device and method capable of minimizing a time for memory allocation and a service response delay time such that a granted memory is initialized and registered based on a topology map configured by recognizing a connection topology of a physical memory of a granted node having a high-capacity memory and a plurality of host channel adaptors (HCAs) and the HCAs, in order to provide a memory service in a memory cloud that provides a distributed integrated memory through a plurality of granted memory nodes connected via a high-speed and low-latency network.

According to an aspect of the present invention, there is provided a granted memory providing system. The system includes a topology map generating unit configured to investigate a connection structure of a host channel adapter, a processor, and a memory of a granted node and generate a topology map of the connection structure; a granted memory initializing unit configured to allocate and register a memory area to be used as a granted memory in the memory based on the topology map and generate access authority information on the area; and a granted node registration requesting unit configured to request registration of the granted node from a meta server when a task of initializing the granted memory is completed.

The granted memory initializing unit may check a memory connected to the host channel adapter through the topology map, and allocate and register a memory area to be used as the granted memory in the memory connected to each host channel adapter.

The granted memory initializing unit may check the number of host channel adapters of the granted node through the topology map, and allocate an area to be used as the granted memory for each host channel adapter when there are the plurality of host channel adapters.

When there are the plurality of host channel adapters, the granted memory initializing unit may check whether the adapters have a non-uniform memory access structure through the topology map. When it is checked that the adapters have the non-uniform memory access structure through the topology map, the granted memory initializing unit may allocate a memory area to be used as the granted memory by a size requested for a management allocation area in a memory area of a socket directly connected to each host channel adapter. When it is checked that the adapters have no non-uniform memory access structure through the topology map, the granted memory initializing unit may divide a management memory area by the number of host channel adapters and allocate a memory area as the size of same amount of physical memory for each host channel adapter.

The topology map generating unit may generate the topology map when a granted memory initialization task is requested from the granted node.

According to another aspect of the present invention, there is provided a method of registering a granted memory. The method includes investigating a memory connection structure of a granted node and generating a topology map; allocating a granted memory area in a memory of the granted node based on the topology map; and transmitting a registration request of the granted node to a meta server when the granted memory area allocation is completed. In the allocating of the granted memory area in the memory based on the topology map, when the granted node has a plurality of host channel adapters, the granted memory area may be allocated in a memory directly connected to each host channel adapter.

According to still another aspect of the present invention, there is provided a method of allocating a granted memory. The method includes receiving, by a meta server, a granted memory allocation request from a client node; selecting a granted node that can allocate a granted memory when the allocation request is received; checking a host channel adapter of the selected granted node and a memory connected to the host channel adapter through a topology map of the selected granted node; and allocating a granted memory area of a memory connected to each host channel adapter. In the allocating of the granted memory area of the memory connected to each host channel adapter, when there are a plurality of host channel adapters, an allocation-requested memory size may be divided by the number of host channel adapters to calculate an allocated memory size of each host channel adapter.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1A, 1B, 2A and 2B are block diagrams illustrating a structure of a conventional distributed integrated memory system;

FIGS. 3A and 3B are diagrams illustrating a structure and a concept of a granted memory providing system according to an embodiment of the present invention;

FIGS. 4 to 7 are diagrams illustrating a process of a method of registering and allocating a granted memory according to an embodiment of the present invention; and

FIG. 8 is a block diagram showing a computer system implemented according to an embodiment of the present invention.

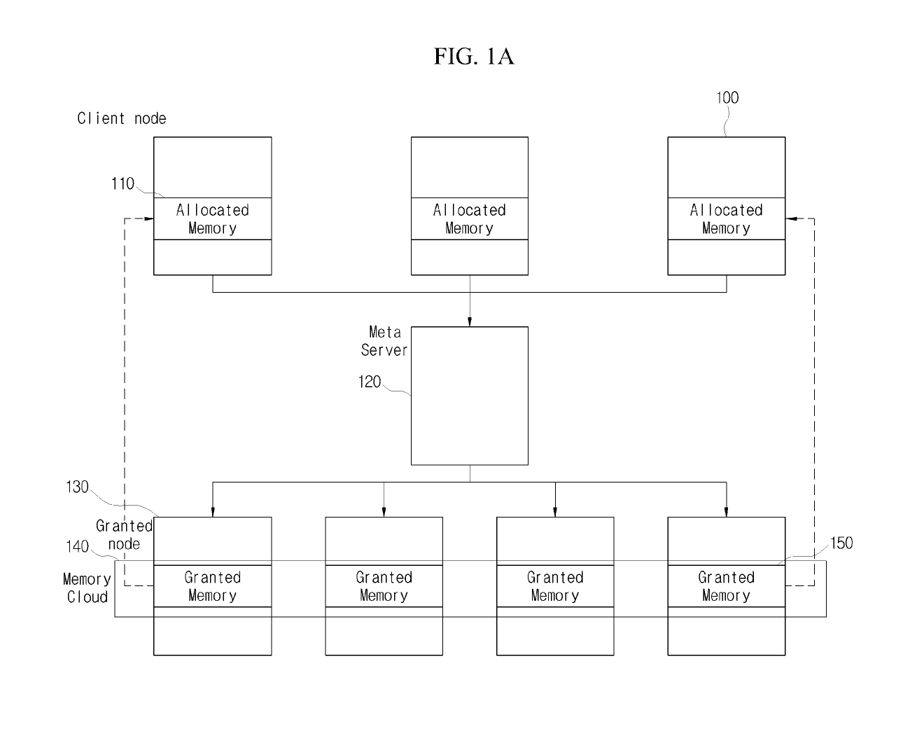

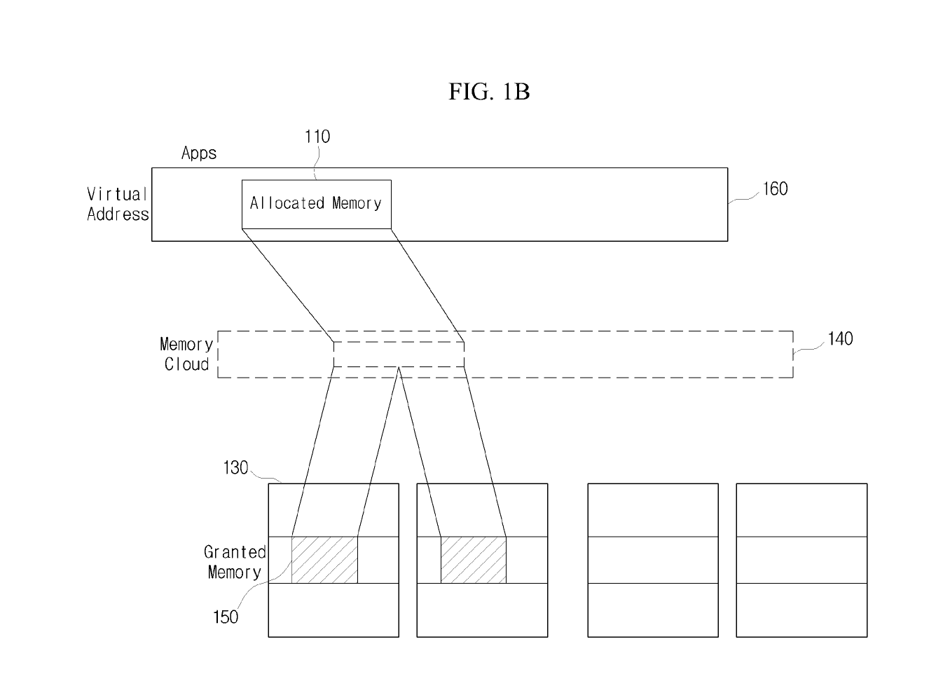

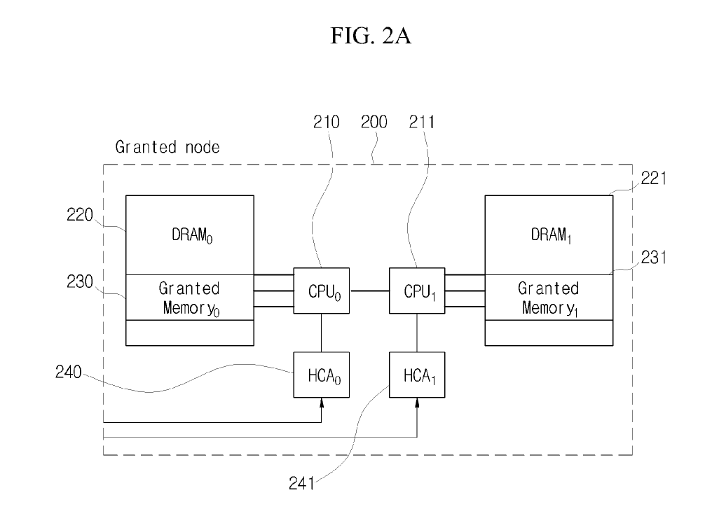

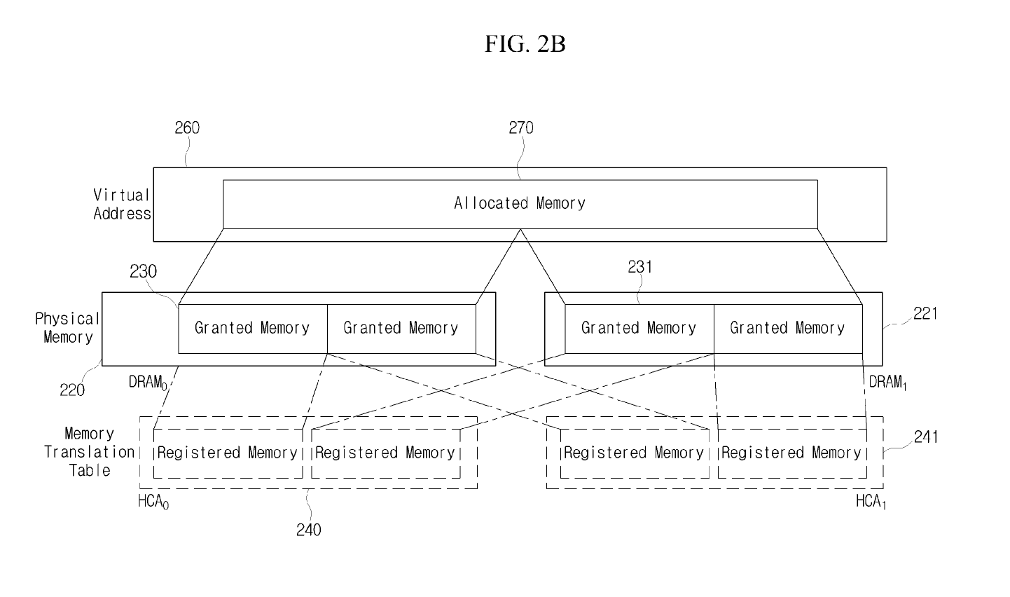

### DETAILED DESCRIPTION OF EXEMPLARY EMBODIMENTS

Advantages, features, and methods of achieving them of the present invention will be apparent with reference to the accompanying drawings and embodiments to be described in detail. However, the present invention is not limited to the following embodiments but may be implemented in various different forms. The embodiments are provided to fully disclose the present invention and to fully provide the scope of the invention for those skilled in the art. The present invention is defined by the appended claims.

The terminology used herein to describe embodiments is not intended to limit the present invention. In this specification, the articles “a,” “an,” and “the” are intended to include the plural forms as well, unless the context clearly indicates otherwise. The terms “comprises” and/or “comprising” used herein specify the presence of stated components, steps, operations and/or elements but do not preclude the presence or addition of one or more other components, steps, operations and/or elements. Hereinafter, the embodiments of the present invention will be described in detail with reference to the accompanying drawings.

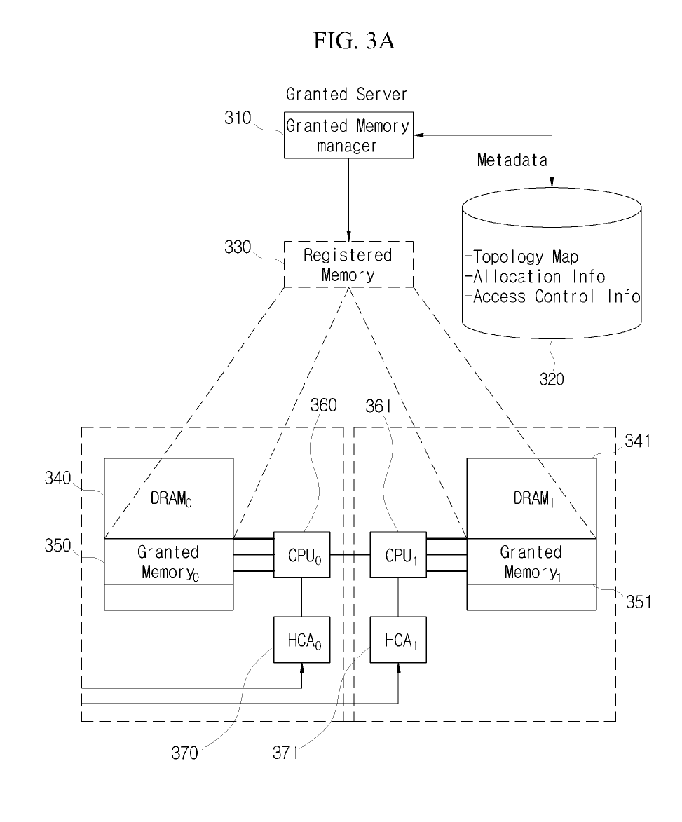

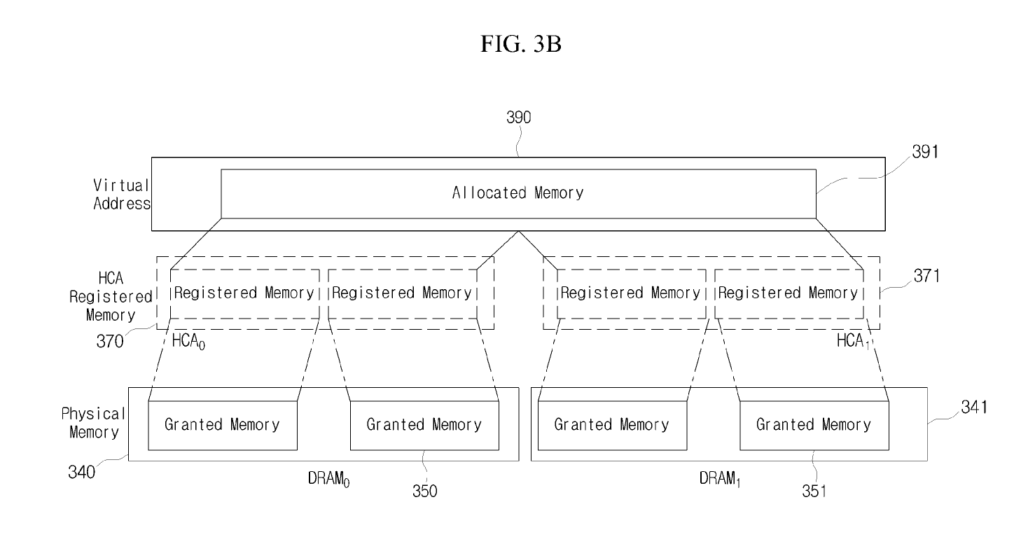

FIGS. 3A and 3B are diagrams illustrating an overall structure and a concept of a granted memory providing system based on topology recognition according to an embodiment of the present invention.

In a distributed integrated memory system in the related art, when a granted memory of a granted node is initialized and registered, a connection structure of a host channel adapter (HCA), a processor (CPU), and a memory (DRAM) is not considered. Therefore, it is difficult to optimally register and allocate the memory, which results in performance degradation due to a granted memory response time increase.

In order to address the above-described problems in the related art, in the present invention, a topology of the granted node is recognized. In order to provide optimal allocation between the HCA and the memory and access management, the HCA and the memory connected to the same socket are mapped based on the topology, and the mapping is reflected when the granted memory is initialized and allocated.

Although not specifically illustrated in FIGS. 3A and 3B, a granted memory providing system according to an embodiment of the present invention may include a topology map generating unit, a granted memory initializing unit, and a granted node registration requesting unit.

Before a granted memory registration task is performed, the topology map generating unit investigates the system and the connection structure to configure a topology map. The topology map is mapping information on a connection configuration of the HCA, the processor, and the physical memory. It is possible to optimally perform granted memory registration using the topology map.

When the granted memory is initialized and registered, the granted memory initializing unit utilizes the topology map of the granted node generated by the topology map generating unit.

As illustrated in FIG. 3B, when a virtual memory 391 to be used as a granted memory area is allocated out of a virtual memory area 390, a task of initializing and registering a memory area of a granted memory 350 area of a DRAM₀ 340 is performed through an HCA₀ 370, and a task of initializing and registering a memory area of a granted memory 351 area of a DRAM₁ 341 is processed through an HCA₁ 371.

Therefore, when the initialization task of the granted memory is performed based on the topology map, the granted memory is efficiently configured and the memory area is registered so that a memory allocation time, a service access time, and a response time may be minimized.

When the initialization task of the granted node is completed, the granted node registration requesting unit transmits information on the granted node, information on a granted memory allocation area, and access authority information to a meta server, and requests registration of the granted node.

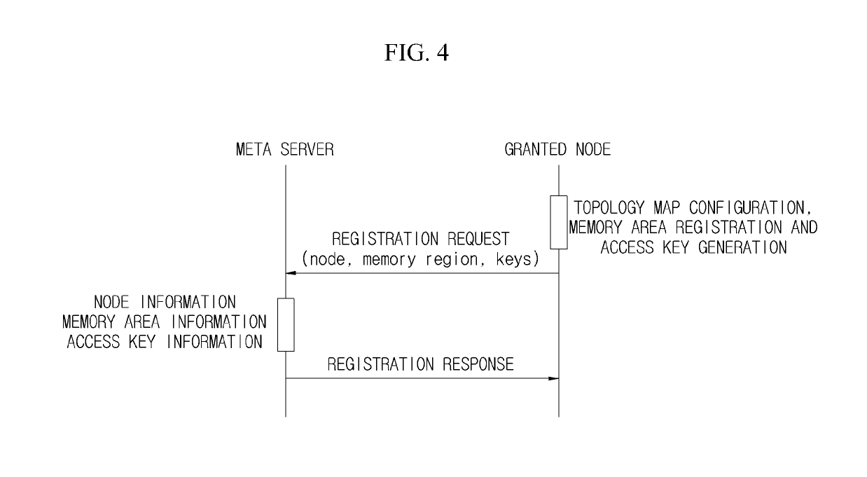

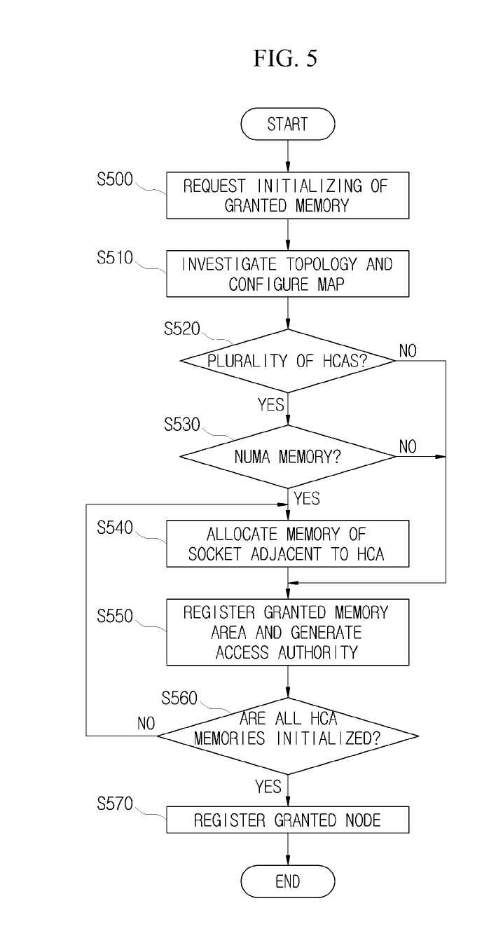

FIGS. 4 and 5 illustrate a process of a method of registering a granted memory according to an embodiment of the present invention. FIG. 4 illustrates an overall flow of a process of registering a granted memory between the meta server and the granted node, and FIG. 5 illustrates a detailed process thereof.

As illustrated in FIG. 5, when the granted memory providing system according to the embodiment of the present invention receives a granted memory initializing request and receives topology information (S500), a task of investigating a topology and configuring a map is performed using the received topology information and resource information of the system (S510).

After the map configuration task is completed, a task of initializing and registering an actual memory is performed. First, it is examined whether there are a plurality of HCAs (S520). When there are the plurality of HCAs in a granted node, memory areas to be used as the granted memory is determined the allocation size for each HCA in a node divided by the number of HCAs and a management allocation area for each HCA is registered (S540).

In addition, when there are the plurality of HCAs, it is examined whether a structure thereof is a non-uniform memory access (NUMA) memory structure (S530). When a structure thereof is the NUMA memory structure, a memory is allocated from a DRAM area of a socket connected to the HCA by a size requested from the HCA as the management allocation area (S540). When a structure thereof is not the NUMA memory structure, since all HCAs have the same access cost for the granted memory area, a management memory area is divided by the number of HCAs, and the following process is performed.

When there are not a plurality of HCAs, tasks of allocating, registering, and generating access authority are performed on all granted memory areas at once.

When allocation of the granted memory is completed, the allocated granted memory area is registered and access authority for an entire area is generated (S550).

When the tasks of initializing the granted memory area and generating the access authority for the HCA are completed, it is examined whether there is an HCA and a granted memory area that need to be additionally initialized (S560). When there is the additional HCA, the tasks of allocating, registering, and generating access authority for the granted memory area managed by the HCA from S540 to S550 are repeatedly performed.

When all initialization tasks are completed, registration request of the granted memory node is transmitted to the meta server (S570). The meta server integrates granted memories of each of the granted memory nodes to configure the memory cloud, and is able to provide the memory service to the client node. Based on topology map information, granted memory node initialization is performed such that the memory of the socket connected to the HCA is allocated as the granted memory area and the memory area is registered.

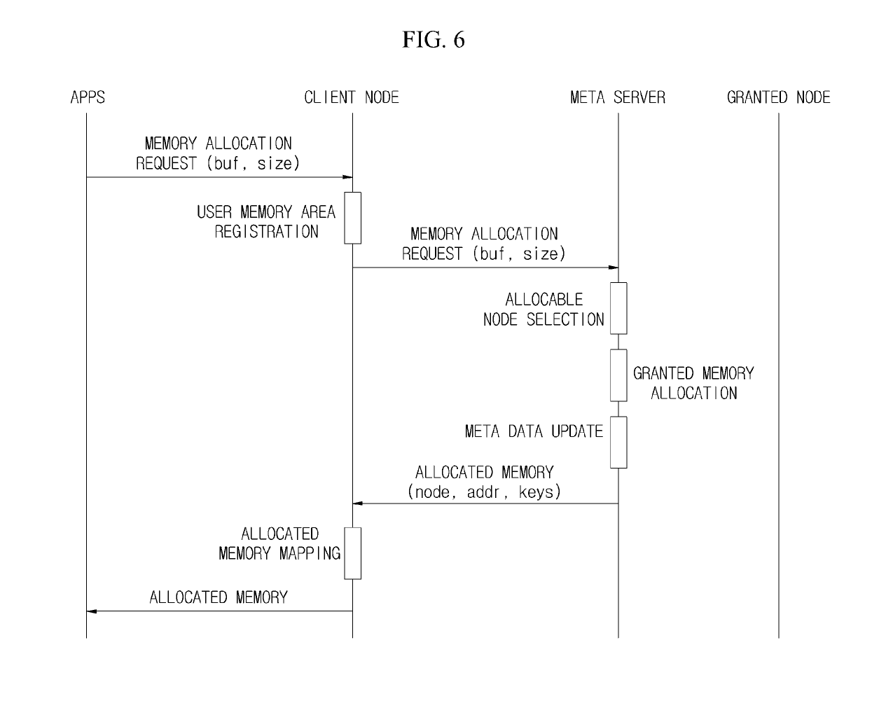

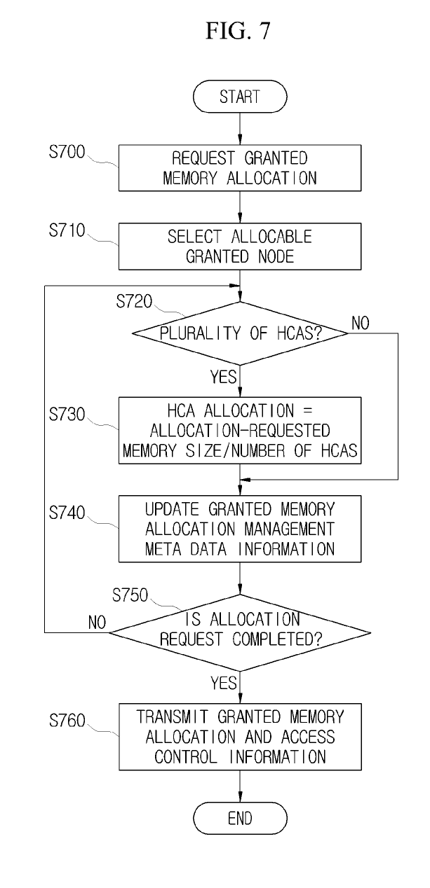

FIGS. 6 and 7 illustrate a process of a method of allocating a granted memory according to an embodiment of the present invention. FIG. 6 illustrates an overall process of allocating a granted memory between a client node and a meta server. FIG. 7 illustrates a detailed process thereof.

As illustrated in FIG. 6, a memory allocation request of an application for the memory cloud is transmitted to the meta server through a memory client of the client node. The meta server allocates a granted memory to be actually mapped out of the memory cloud, and sends information on the allocated granted node and the memory area to the client node as a response.

A process of the meta server allocating the granted memory based on topology recognition is as follows.

As illustrated in FIG. 7, when an allocation request for the memory cloud is transmitted from the client node (S700), the meta server first selects an allocable granted memory node (S710). Selection of the granted memory node is performed by round robin scheduling for load distribution and load balancing.

When the granted memory node is selected, it is checked whether the node has a plurality of HCAs (S720). When there are the plurality of HCAs, the allocation-requested memory size is divided by the number of HCAs to obtain a memory size to be allocated in order to obtain a memory size required for each HCA (S730). When allocation of the granted memory area is completed, allocation of the granted memory area for the HCA and metadata information on free memory space are updated (S740).

When allocation tasks for all HCAs are completed (S750), the memory allocation request for the corresponding granted node is terminated. When a plurality of granted memory nodes are selected in response to the memory allocation request of the client node, the same task is repeatedly performed on the selected nodes. When allocation of the memory size requested from the client node is completed, allocated granted node information, granted memory area information, and access authority information are transmitted as a response (S760).

When the granted memory node has the plurality of HCAs, the memory allocated from the granted node is equally allocated for each HCA so that a response time for the memory service may be minimized and a total service bandwidth may be optimized.

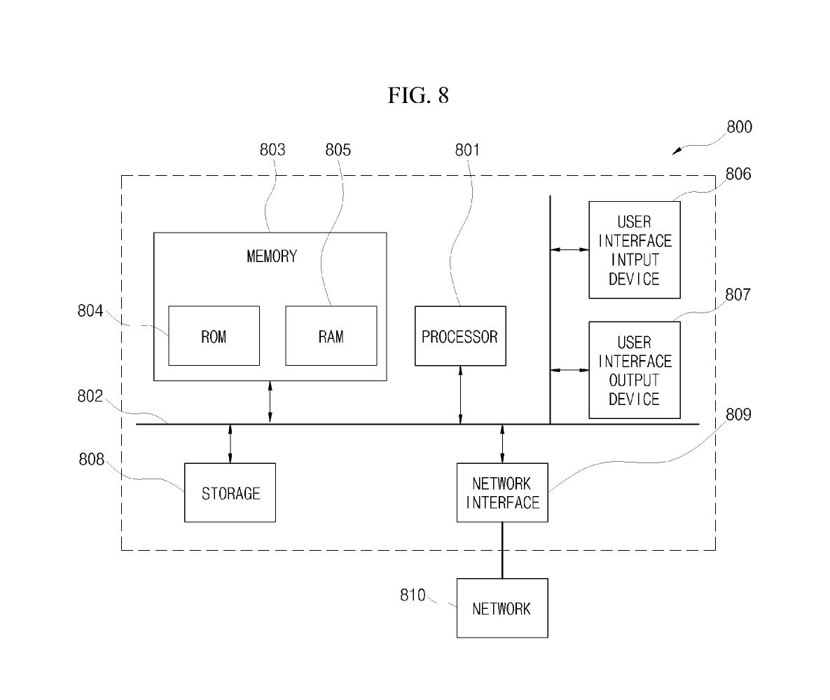

An embodiment of the present invention may be implemented in a computer system, e.g., as a computer readable medium. As shown in FIG. 8, a computer system 800 may include one or more of a processor 801, a memory 803, a user input device 806, a user output device 807, and a storage 808, each of which communicates through a bus 802. The computer system 800 may also include a network interface 809 that is coupled to a network 810. The processor 801 may be a central processing unit (CPU) or a semiconductor device that executes processing instructions stored in the memory 803 and/or the storage 808. The memory 803 and the storage 808 may include various forms of volatile or non-volatile storage media. For example, the memory 803 may include a read-only memory (ROM) 804 and a random access memory (RAM) 805.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the structure of the present invention, by optimizing memory registration of the granted memory node, and mapping and a configuration of the HCA and the memory service area, it is possible to minimize a memory access delay and a response time. As a result, it is possible to decrease a memory service response time of an application and a transfer load of a high-capacity memory service. That is, it is possible to minimize a time for memory allocation of the application using the memory service and an access delay time for memory area read and write.

In addition, it is possible to increase a bandwidth of the granted node memory service according to a uniform load distribution through the plurality of HCAs for the memory service.

The above description is only an example describing the scope and spirit of the present invention. Those skilled in the art may variously change and modify the embodiments without departing from the spirit and scope of the present invention. Therefore, the embodiments of the present invention should be considered in a descriptive sense and not for purpose of limitation. The scope of the invention is not limited to these embodiments. The scope of the invention is defined by the appended claims and encompasses all modifications and equivalents falling within the scope of the appended claims.

What is claimed is:

1. A granted memory providing system, comprising:
a topology map generating unit configured to investigate a connection structure of a host channel adapter, a processor, and a memory of a granted node, and generate a topology map of the connection structure;
a granted memory initializing unit configured to allocate and register an area to be used as a granted memory in the memory based on the topology map and generate access authority information on the area; and
a granted node registration requesting unit configured to request registration of the granted node from a meta server when a task of initializing the granted memory is completed.

2. The system of claim 1,
wherein the granted memory initializing unit checks a memory connected to the host channel adapter through the topology map, and allocates and registers an area to be used as the granted memory in the memory connected to each host channel adapter.

3. The system of claim 1,
wherein the granted memory initializing unit checks the number of host channel adapters of the granted node through the topology map, and allocates an area to be used as the granted memory for each host channel adapter when there are the plurality of host channel adapters.

4. The system of claim 1,
wherein the granted memory initializing unit equally allocates an area to be used as the granted memory in the memory connected to each host channel adapter when there are the plurality of host channel adapters.

5. The system of claim 1,
wherein, when there are the plurality of host channel adapters, the granted memory initializing unit checks whether the adapters have a non-uniform memory access structure through the topology map and allocates an area to be used as the granted memory.

6. The system of claim 5,
wherein, when it is checked that the adapters have the non-uniform memory access structure through the topology map, the granted memory initializing unit allocates an area to be used as the granted memory by a size requested for a management allocation area in a memory area of a socket connected to each host channel adapter.

7. The system of claim 5,
wherein, when it is checked that the adapters have no non-uniform memory access structure through the topology map, the granted memory initializing unit divides a management memory area by the number of host channel adapters and allocates an area to be used as the granted memory.

8. The system of claim 1,
wherein the topology map generating unit generates the topology map when a granted memory initialization task is requested from the granted node.

9. A method of registering a granted memory, comprising:
investigating a memory connection structure of a granted node and generating a topology map;
allocating a granted memory area in a memory of the granted node based on the topology map; and
transmitting a registration request of the granted node to a meta server when the granted memory area allocation is completed.

10. The method of claim 9,
wherein, in the investigating of the memory connection structure of the granted node and generating of the topology map,
a connection structure of a host channel adapter, a processor, and a memory of the granted node is investigated and a topology map of the connection structure is generated.

11. The method of claim 9,
wherein, in the allocating of the granted memory area in the memory based on the topology map,
when the granted node has a plurality of host channel adapters, the granted memory area is allocated in a memory connected to each host channel adapter.

12. The method of claim 9,
wherein, in the allocating of the granted memory area in the memory based on the topology map,
when the granted node has a plurality of host channel adapters, it is checked whether a memory connection structure of the granted node is a non-uniform memory access structure, and the granted memory area is allocated.

13. The method of claim 9,
wherein, in the allocating of the granted memory area in the memory based on the topology map, when the granted node has a plurality of host channel adapters, the granted memory area is equally allocated in each host channel adapter.

14. The method of claim 9,
wherein, in the transmitting of the registration request of the granted node to the meta server when the granted memory area allocation is completed, a registration request including information on a granted memory area allocated for each host channel adapter of the granted node and access authority information.

15. A method of allocating a granted memory, comprising:
receiving, by a meta server, a granted memory allocation request from a client node;
selecting a granted node that can allocate a granted memory when the allocation request is received;
checking a host channel adapter of the selected granted node and a memory connected to the host channel adapter through a topology map of the selected granted node; and
allocating a granted memory area of a memory connected to each host channel adapter.

16. The method of claim 15,
wherein, in the allocating of the granted memory area of the memory connected to each host channel adapter,
when there are a plurality of host channel adapters, an allocation-requested memory size is divided by the number of host channel adapters to calculate an allocated memory size of each host channel adapter.

17. The method of claim 15,
wherein, in the selecting of the granted node that can allocate the granted memory when the allocation request is received,
the granted node that can allocate the granted memory is selected from among granted nodes registered in the meta server by round robin scheduling.

18. The method of claim 15, further comprising
repeatedly performing a process of allocating the granted memory for each granted node when there are a plurality of selected granted nodes.

19. The method of claim 15, further comprising
updating information on a free memory space and granted memory allocation information of the granted node stored in the meta server when allocation of the granted memory of the selected granted node is completed.

20. The method of claim 15, further comprising
transmitting allocated granted node information, granted memory area information, and access authority information to the client node when allocation of the granted memory of the selected granted node is completed.
